(19) United States
(12) Patent Application Publication
(10) Pub. No.: US 2011/0243509 A1
(43) Pub. Date: Oct. 6, 2011

(54) OPTO-ELECTRONIC TRANSCEIVER MODULE SYSTEM

(75) Inventors: Tak Kui Wang, Cupertino, CA (US); Chung-yi Su, Fremont, CA (US)

(73) Assignee: AVAGO TECHNOLOGIES FIBER IP (SINGAPORE) PTE. LTD., SINGAPORE (SG)

(21) Appl. No.: 12/754,148

(22) Filed: Apr. 5, 2010

(51) Int. Cl. G02B 6/43

(52) U.S. Cl. 385/88

(57) ABSTRACT

An opto-electronic module system includes an opto-electronic module having an optics engine module mounted on an opto-electronic module substrate. The optics engine module includes an opto-electronic light source and an opto-electronic light receiver mounted on an optics engine module substrate. The opto-electronic module substrate has an aperture that is aligned with the opto-electronic light source and the opto-electronic light receiver.

### BACKGROUND

In an optical communication system, it is generally necessary to couple an optical fiber to an opto-electronic transmitter, receiver or transceiver device and to, in turn, couple the device to an electronic system such as a switching system or processing system. These connections can be facilitated by modularizing the transceiver device. An opto-electronic transceiver module includes an opto-electronic light source, such as a laser, and an opto-electronic light receiver, such as a photodiode, and may also include various electronic circuitry associated with the laser and photodiode. For example, driver circuitry can be included for driving the laser in response to electronic signals received from the electronic system. Receiver circuitry can be included for processing the signals produced by the photodiode and providing output signals to the electronic system.

Portions of the opto-electronic and electronic circuitry can be manufactured using conventional microelectronic processes, such as fabricating multiple devices on a wafer and then dicing or singulating the wafer into individual devices. It is desirable to maximize process yield, i.e., the ratio of usable devices to unusable devices resulting from the process.

Various opto-electronic transceiver module configurations are known. For example, an opto-electronic transceiver module can be mounted in the electronic system on an edge of a circuit board adjacent an opening in a front panel of the electronic system, so that an optical cable can be plugged into the opto-electronic transceiver module via the front panel. Such opto-electronic transceiver modules are commonly referred to as edge-mounted. Another opto-electronic transceiver module configuration is known as mid-plane mounted because the transceiver module is mounted on the surface of a circuit board (plane) rather than on an edge of the circuit board. Still other opto-electronic transceiver module configurations are known.

It would be desirable to provide opto-electronic transceiver modules having a configuration or structure that promotes manufacturing economy and yield.

### SUMMARY

Embodiments of the present invention relate to an opto-electronic module system having an opto-electronic module in which an optics engine module is mounted on an opto-electronic module substrate. The opto-electronic module substrate has an upper surface, a lower surface, and an aperture extending between the upper surface and lower surface. The optics engine module includes an optics engine module substrate having an upper surface and a lower surface, an opto-electronic light source mounted on the upper surface, and an opto-electronic light receiver mounted on the upper surface. The optics engine module substrate is made of a material transparent to frequencies of light produced by the opto-electronic light source and sensed by the opto-electronic light receiver. The optics engine module is mounted over the aperture of the opto-electronic module substrate in an orientation in which the lower surface of the optics engine module substrate is in contact with the upper surface of the opto-electronic module substrate and in which a first optical path between the opto-electronic light source and the aperture of the opto-electronic module substrate passes through the material of the optics engine module substrate and a second optical path between the opto-electronic light receiver and the aperture of the opto-electronic module substrate passes through the material of the optics engine module substrate.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of an opto-electronic transceiver module system, in accordance with an exemplary embodiment of the invention.

FIG. 2 is an enlargement of a portion of FIG. 1, showing the optical connector.

FIG. 3 is a perspective view of the top of the opto-electronic module of the opto-electronic transceiver module system shown in FIG. 1.

FIG. 4 is a perspective view of the bottom of the opto-electronic module of the opto-electronic transceiver module system shown in FIG. 1.

FIG. 5 is a top plan view of the optics engine module of the opto-electronic module shown in FIG. 3.

FIG. 6 is a bottom plan view of the optics engine module of the opto-electronic module shown in FIG. 3.

FIG. 7 is a perspective view of the top of an opto-electronic module, in accordance with another embodiment of the invention.

FIG. 8 is a perspective view of the bottom of the opto-electronic module shown in FIG. 7.

FIG. 9 is a side elevation view showing two opto-electronic modules communicating with each other.

FIG. 10 is a side elevation view of a system comprising a laptop computer and docking station, each partly cut away to show an included opto-electronic module.

### DETAILED DESCRIPTION

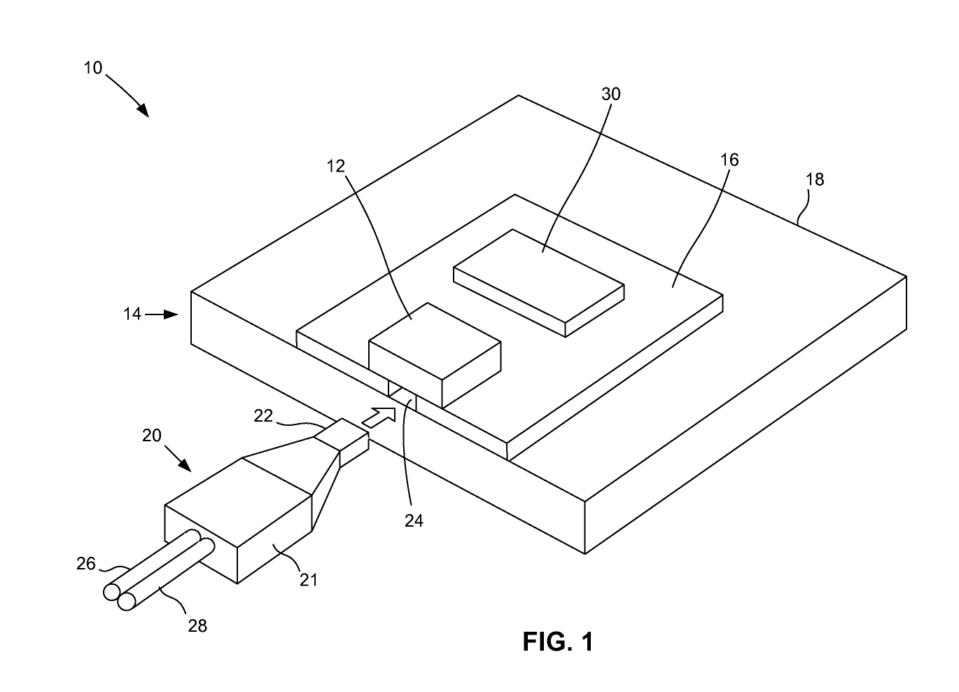

As illustrated in FIG. 1, in an illustrative or exemplary embodiment of the invention, an opto-electronic transceiver module system 10 includes an opto-electronic module 12 mounted on a circuit board substrate 14. Although in the exemplary embodiment the circuit board substrate 14 comprises a circuit board 16 and a lower substrate 18, in other embodiments a circuit board substrate can comprise any suitable structure comprising one or more substantially planar elements such as printed circuit boards.

As further illustrated in FIG. 1, an optical connector 20 includes a body 21 having a distal end 22 that plugs into a slot 24 in the edge of circuit board 16. A transmit optical fiber 26 and a receive optical fiber 28 extend from a proximal end of the body of optical connector 20. Although in the exemplary embodiment slot 24 extends into the edge of circuit board 16 and is bounded on the top by opto-electronic module 12 and on the bottom by lower substrate 18, in other embodiments a slot can be included in a circuit board substrate in any other suitable manner, such as by forming a bore in the edge of the circuit board substrate. Also, although in the exemplary embodiment distal end 22 of optical connector 20 has a rectangular profile, and slot 24 has a correspondingly rectangular profile for receiving distal end 22, in other embodiments these elements can have any other suitable shape that allows optical connector 20 to be mated with the remainder of opto-electronic transceiver module system 10.

Although not shown for purposes of clarity, a mechanism can be included for retaining, aligning, securing, etc., distal end 22 of optical connector 20 in slot 24. The mechanism can include, for example, one or more alignment pins (not shown) in distal end 22 that are received in mating bores (not shown) in slot 24. Alternatively, or in addition, such pins can serve to transmit electrical power or ground signals.

A router integrated circuit 30 or any other electronic circuitry that may be useful in a system in which electrical signals are converted to and from optical signals can also be included. Although not shown for purposes of clarity, circuit traces or similar conductive paths on or in circuit board 16 electrically connect router integrated circuit 30 and opto-electronic module 12. Similarly, connections (not shown) on circuit board 16 provide electrical signal inputs and outputs to and from other circuitry. It should be noted that neither FIG. 1 nor any other drawing figures herein are to scale, though it is contemplated that the combined thickness of opto-electronic module 12 and circuit board 16 can be on the order of a couple of millimeters. Opto-electronic module 12 can be fabricated using conventional microelectronic processing methods.

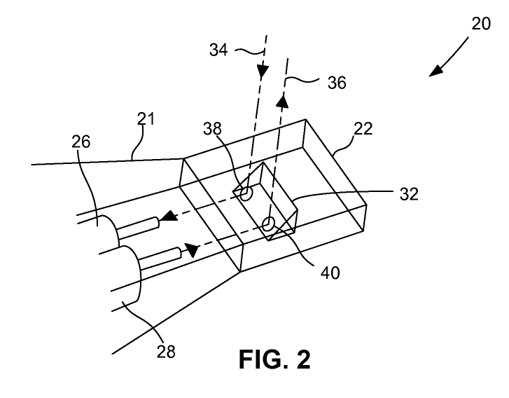

As illustrated in FIG. 2, body 21 of optical connector 20 can be made of a material that is transparent to the light that is communicated via optical fibers 26 and 28, such as a moldable optical thermoplastic. An example of a material that may be suitable is ULTEM® polyetherimide from SABIC (formerly General Electric Plastics Division). A mirror 32 can be molded inside body 21 along with the ends of optical fibers 26 and 28. Mirror 32 is disposed in alignment with the ends of optical fibers 26 and 28 in the following manner. When distal end 22 is in slot 24, light emitted by opto-electronic module 12 along a first axis 34 perpendicular to the direction in which distal end 22 is received in slot 24 (indicated by the arrow in FIG. 1) impinges upon mirror 34 and is reflected at a 90-degree angle into an end of transmit optical fiber 26. Similarly, when distal end 22 is in slot 24, light emitted by an end of receive optical fiber 28 impinges upon mirror 34 and is reflected at a 90-degree angle into opto-electronic module 12 along a second axis 36 parallel to first axis 34. A focusing lens 38 can be included for focusing light on the end of transmit fiber 26, and a collimating lens 40 can be included for collimating light emitted from the end of receive fiber 28.

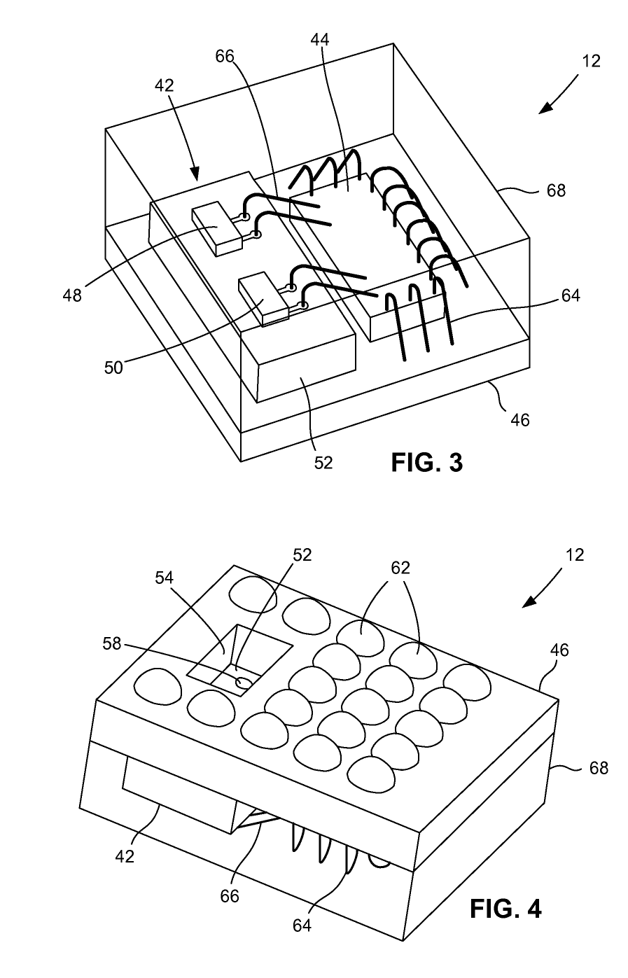

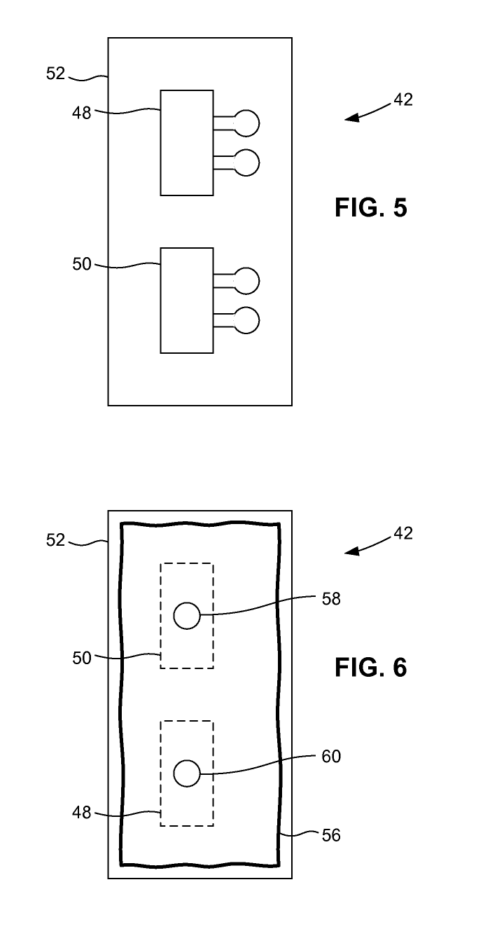

As illustrated in FIGS. 3 and 4, in the exemplary embodiment opto-electronic module 12 includes an optics engine module 42 and a buffer integrated circuit 44 mounted on an opto-electronic module substrate 46. With additional reference to FIG. 5, optics engine module 42 includes an opto-electronic light source 48, such as a vertical cavity surface emitting laser (VCSEL), and an opto-electronic light receiver 50, such as a photodiode, both mounted on an optics engine module substrate 52. Optics engine module substrate 52 can be made of a suitable material that is transparent to the light that is emitted by opto-electronic light source 48 and the light that is detected by opto-electronic light receiver 50, such as glass. As illustrated in FIG. 4, opto-electronic module substrate 46 has an aperture 54. Optics engine module 42 is mounted on opto-electronic module substrate 46 in an orientation in which opto-electronic light source 48 and opto-electronic light receiver 50 are disposed over aperture 54. Opto-electronic light source 48 emits light into aperture 54 along an axis that, when optical connector 20 is plugged into slot 24 (FIGS. 1-2), is coaxial with first axis 34 (FIG. 2). Likewise, opto-electronic light receiver 50 receives light from aperture 54 along an axis that, when optical connector 20 is plugged into slot 24, is coaxial with second axis 36 (FIG. 2). Accordingly, opto-electronic module 12 is mounted on circuit board substrate 16 in an orientation in which aperture 54 is disposed over slot 24. Thus, opto-electronic light source 48 and opto-electronic light receiver 50 are disposed over slot 24.

As illustrated in FIG. 6, a bead of adhesive 56, such as epoxy, can be applied to the bottom surface of optics engine module substrate 52 or, alternatively or in addition, to the top surface of opto-electronic module substrate 46, to adhere and seal these surfaces together, thereby protecting aperture 54 against contamination. Similarly, although not shown for purposes of clarity, a bead of adhesive or other fill material can be applied around the joint between opto-electronic module substrate 46 and circuit board 16 (FIG. 1) to further protect aperture 54 against contamination.

A focusing lens 58 can be formed on the bottom surface of optics engine module substrate 52 to focus light emitted by opto-electronic source 48. Likewise, a collimating lens 60 can be formed on the bottom surface of optics engine module substrate 52 to collimate light for reception by opto-electronic receiver 50.

Referring again to FIG. 4, the bottom surface of opto-electronic module substrate 46 can include an array of electrical contacts 62, such as a Ball Grid Array (BGA). Referring again to FIG. 3, a first set of wirebonds 64 electrically connects buffer integrated circuit 44 to conductive paths (not shown for purposes of clarity) in opto-electronic module substrate 46 and, in turn, to the array of electrical contacts 62. A second set of wirebonds 66 electrically connects optics engine module 42 to buffer integrated circuit 44.

Opto-electronic module 12 can include an overmold 68 of a suitable material, such as epoxy, that encapsulates optics engine module 42, buffer integrated circuit 44, and wirebond sets 64 and 66. The material can be optically transparent, as shown. The seal formed where the bottom surface of optics engine module substrate 52 contacts the top surface of opto-electronic module substrate 46 around aperture 54 prevents the overmold material from seeping into and potentially contaminating aperture 54. As described above, adhesive 56 helps promote a good seal.

It is contemplated that many (e.g., on the order of hundreds or thousands) of optics engine modules 42 can be formed together on an opto-electronic module substrate sheet (not shown) and then singulated into multiple instances of the illustrated optics engine module 42 using microelectronic processing methods well understood by persons skilled in the art. As such methods are well understood, they are not described in detail herein.

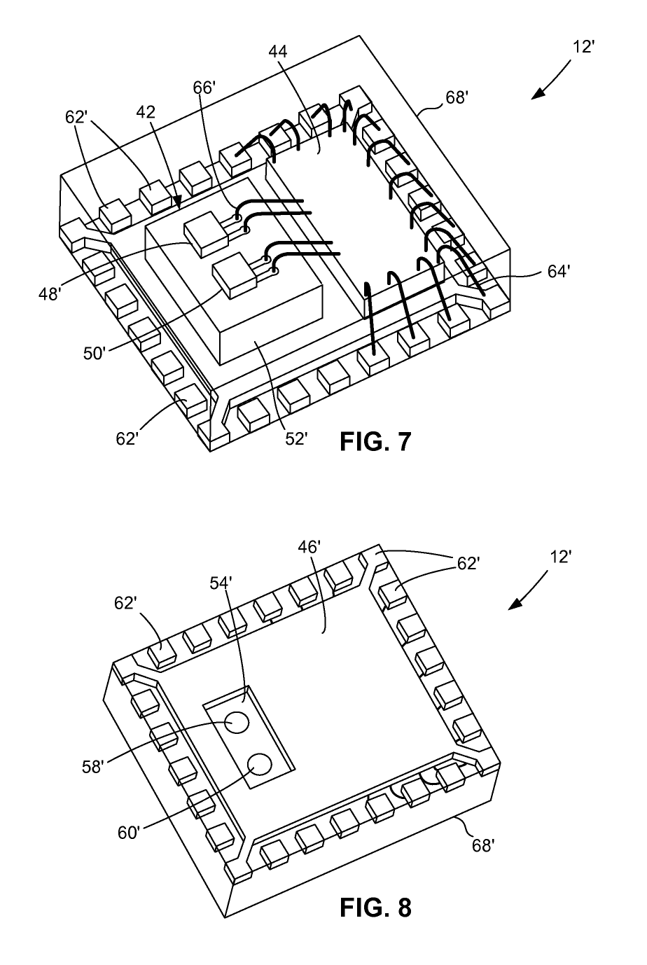

As illustrated in FIGS. 7-8, in another embodiment of the invention, an opto-electronic module 12′ includes the above-described optics engine module 42 and buffer integrated circuit 44 mounted on an opto-electronic module substrate 46′. In this embodiment, opto-electronic module substrate 46′ and the manner in which optics engine module 42 and buffer integrated circuit 44 are mounted on it generally conform to the characteristics of a packaging technology commonly referred to in the art as Quad Flat No-leads, or QFN. In accordance with QFN characteristics, opto-electronic module substrate 46′ comprises a metal (e.g., copper) lead frame that provides thermal as well as electrical conductivity, as well as an array of electrical contact pads 62′ that are distributed about the periphery of opto-electronic module substrate 46′. The first set of wirebonds 64′ electrically couples buffer integrated circuit 44 to the tops of pads 62′. The bottoms of pads 62′ (FIG. 8) can be soldered or otherwise electrically connected to a circuit board (not shown) similar to circuit board 16 in the embodiment described above with regard to FIGS. 1-6. Other aspects and features of the embodiment illustrated in FIGS. 7-8 are similar to those of the embodiment described above with regard to FIGS. 1-6 and are therefore not described in similar detail. Opto-electronic module 12′ also includes an overmold 68′ that encapsulates optics engine module 42, buffer integrated circuit 44, and wirebond sets 64′ and 66′.

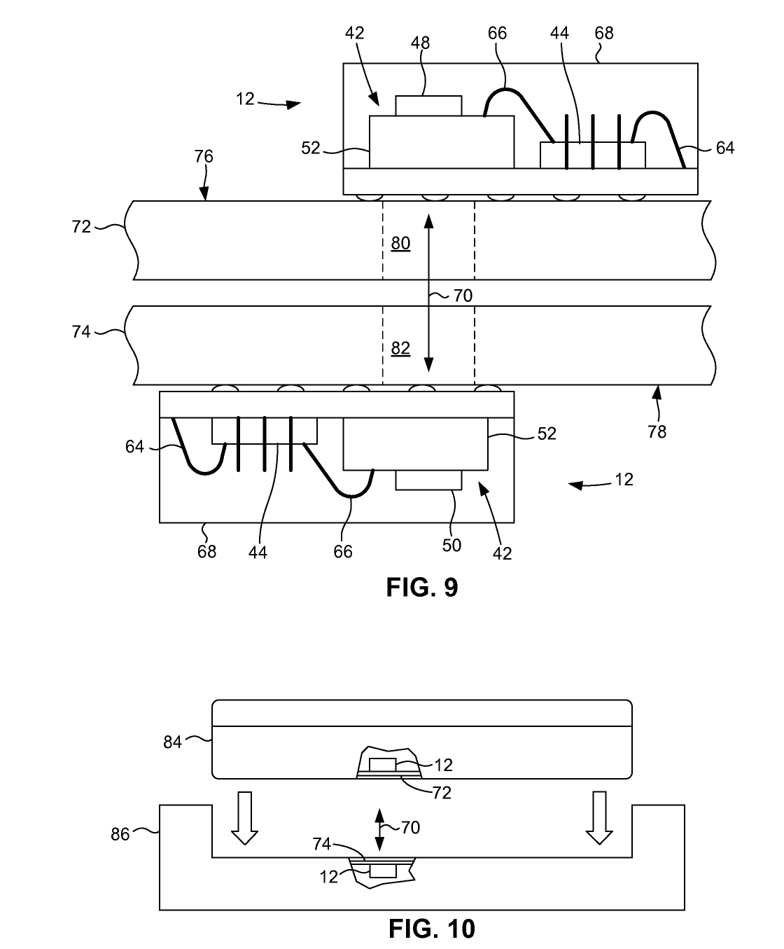

As illustrated in FIG. 9, two of the above-described opto-electronic modules 12 can directly communicate bidirectional optical signals 70 with one another, i.e., without an optical fiber or similar medium. The two opto-electronic modules 12 can be mounted on opposing sides or portions of a structure, such as a structure comprising two parallel circuit boards 72 and 74, or mounted in any other suitable way. In the illustrated embodiment, a first opto-electronic module 12 is mounted on a surface 76 of circuit board 72, and a second opto-electronic module 12 is mounted on an opposing surface 78 of circuit board 74. Circuit boards 72 and 74 have openings or apertures 80 and 82, respectively, which are aligned with one another. The first and second opto-electronic modules 12 are mounted over apertures 80 and 82 of the respective circuit boards 72 and 74. In operation, the opto-electronic light source 48 of the first opto-electronic module 12 can transmit an optical signal through apertures 80 and 82 that impinges on the opto-electronic light receiver 50 of the second opto-electronic module 12. Conversely, the opto-electronic light source 48 of the second opto-electronic module 12 can transmit an optical signal through apertures 82 and 80 that impinges on the opto-electronic light receiver 50 of the first opto-electronic module 12.

Circuit boards 72 and 74 can be part of a system having two user-separable parts. For example, as illustrated in FIG. 10, circuit board 72 can be part of a laptop computer 84, and circuit board 74 can be part of a docking station 86 to which the laptop can be connected. When laptop computer 84 is seated in, i.e., docked with, docking station 86, the first and second opto-electronic modules 12 are aligned with one another, thereby allowing high-speed bidirectional communication of optical signals 70 between laptop computer 84 and docking station 86.

One or more illustrative embodiments of the invention have been described above. However, it is to be understood that the invention is defined by the appended claims and is not limited to the specific embodiments described.

What is claimed is:

1. An opto-electronic module system, comprising:
an opto-electronic module comprising:
an opto-electronic module substrate having an upper surface, a lower surface, and an aperture extending between the upper surface and lower surface of the opto-electronic module substrate; and
an optics engine module, the optics engine module comprising an optics engine module substrate having an upper surface and a lower surface, an opto-electronic light source mounted on the upper surface of the optics engine module substrate and an opto-electronic light receiver mounted on the upper surface of the optics engine module substrate, the optics engine module substrate made of a material transparent to frequencies of light produced by the opto-electronic light source and transparent to frequencies of light sensed by the opto-electronic light receiver, the optics engine module mounted over the aperture of the opto-electronic module substrate in an orientation with the lower surface of the optics engine module substrate in contact with the upper surface of the opto-electronic module substrate and wherein a first optical path between the opto-electronic light source and the aperture of the opto-electronic module substrate passes through the material of the optics engine module substrate and wherein a second optical path between the opto-electronic light receiver and the aperture of the opto-electronic module substrate passes through the material of the optics engine module substrate.

2. The opto-electronic module system claimed in claim 1, wherein:
the opto-electronic module further comprises a dielectric overmold extending over the opto-electronic module substrate and encapsulating the optics engine module; and
the optics engine module is mounted on the opto-electronic module substrate by a bead of adhesive surrounding the aperture of the opto-electronic module substrate and sealing the aperture between the optics engine module and the opto-electronic module substrate.

3. The opto-electronic module system claimed in claim 2, wherein the opto-electronic module further comprises:
a buffer integrated circuit mounted on the optics engine module substrate;
a first plurality of wirebonds electrically connecting the buffer integrated circuit to conductors on the opto-electronic module substrate; and
a second plurality of wirebonds electrically connecting the buffer integrated circuit to the optics engine module;
wherein the dielectric overmold encapsulates the optics engine module, the buffer integrated circuit, the first plurality of wirebonds, and the second plurality of wirebonds.

4. The opto-electronic module system claimed in claim 1, wherein the opto-electronic module substrate comprises a lead frame.

5. The opto-electronic module system claimed in claim 1, wherein the opto-electronic module further comprises an array of electrical contacts on the lower surface of the opto-electronic module substrate.

6. The opto-electronic module system claimed in claim 5, wherein the array of electrical contacts is a ball grid array (BGA).

7. The opto-electronic module system claimed in claim 1, wherein the optics engine module further comprises:
a first lens aligned with the opto-electronic light source; and
a second lens aligned with the opto-electronic light receiver.

8. The opto-electronic module system claimed in claim 1, further comprising a circuit board substrate having a surface and an edge, the edge having a slot extending from within the circuit board substrate to the surface of the circuit board substrate, wherein the opto-electronic module is mounted on the circuit board substrate in an orientation with the aperture of the opto-electronic module substrate disposed over the slot in the edge of the circuit board substrate.

9. The opto-electronic module system claimed in claim 8, further comprising an optical connector mateable with the slot, the optical connector having a connector first optical axis aligned with an optical fiber port, a connector second optical axis perpendicular to the connector first optical axis, and a mirror oriented at a 45-degree angle to the connector first optical axis and the connector second optical axis, wherein the connector second optical axis is aligned with one of the opto-electronic light source and opto-electronic light receiver when the optical connector is mated with the slot.

10. A method of operation of an opto-electronic module system, the opto-electronic module system comprising an opto-electronic module, the opto-electronic module comprising an opto-electronic module substrate and an optics engine module, the opto-electronic module substrate having an upper surface, a lower surface, and an aperture extending between the upper surface and lower surface of the opto-electronic module substrate, the optics engine module comprising an optics engine module substrate having an upper surface and a lower surface, an opto-electronic light source mounted on the upper surface of the optics engine module substrate and an opto-electronic light receiver mounted on the upper surface of the optics engine module substrate, the optics engine module substrate made of a material transparent to frequencies of light produced by the opto-electronic light source and transparent to frequencies of light sensed by the opto-electronic light receiver, the optics engine module mounted over the aperture of the opto-electronic module substrate in an orientation with the lower surface of the optics engine module substrate in contact with the upper surface of the opto-electronic module substrate, the method comprising:
the opto-electronic light source emitting light through the optics engine module substrate and into the aperture; and
the opto-electronic light receiver receiving light through the material of the optics engine module substrate from the aperture.

11. The method claimed in claim 10, wherein:
the opto-electronic module further comprises a dielectric overmold extending over the opto-electronic module substrate and encapsulating the optics engine module; and
the optics engine module is mounted on the opto-electronic module substrate by a bead of adhesive surrounding the aperture of the opto-electronic module substrate and sealing the aperture between the optics engine module and the opto-electronic module substrate.

12. The method claimed in claim 11, wherein the opto-electronic module further comprises:
a buffer integrated circuit mounted on the optics engine module substrate;
a first plurality of wirebonds electrically connecting the buffer integrated circuit to conductors on the opto-electronic module substrate; and
a second plurality of wirebonds electrically connecting the buffer integrated circuit to the optics engine module;
wherein the dielectric overmold encapsulates the optics engine module, the buffer integrated circuit, the first plurality of wirebonds, and the second plurality of wirebonds.

13. The method claimed in claim 10, wherein the opto-electronic module substrate comprises a lead frame.

14. The method claimed in claim 10, wherein the opto-electronic module further comprises an array of electrical contacts on the lower surface of the opto-electronic module substrate.

15. The method claimed in claim 14, wherein the array of electrical contacts is a ball grid array (BGA).

16. The method claimed in claim 10, wherein the optics engine module further comprises:
a first lens aligned with the opto-electronic light source; and
a second lens aligned with the opto-electronic light receiver.

17. The method claimed in claim 10, wherein the opto-electronic module system further comprises a circuit board substrate having a surface and an edge, the edge having a slot extending from within the circuit board substrate to the surface of the circuit board substrate, wherein the method further comprises, and the opto-electronic module is mounted on the circuit board substrate in an orientation with the aperture of the opto-electronic module substrate disposed over the slot in the edge of the circuit board substrate, and wherein the method further comprises receiving an optical connector in the slot, the optical connector having a connector first optical axis aligned with an optical fiber port, a connector second optical axis perpendicular to the connector first optical axis, and a mirror oriented at a 45-degree angle to the connector first optical axis and the connector second optical axis, wherein the connector second optical axis is aligned with one of the opto-electronic light source and opto-electronic light receiver when the optical connector is received in the slot.

18. The method claimed in claim 10, wherein the opto-electronic module system comprises a first opto-electronic module mounted on a first side of a structure and a second opto-electronic module mounted on a second side of a structure, the structure having a structure opening extending from the first side to the second side, the method further comprising:
the first opto-electronic module emitting a first optical signal into the structure opening; and
the second opto-electronic module receiving the first optical signal through the structure opening.

19. The method claimed in claim 18, wherein the structure comprises a first circuit board having a first opening and a second circuit board having a second opening, the first circuit board mounted parallel to the second circuit board with the first opening aligned with the second opening, the first opto-electronic module mounted on the first circuit board over the first opening, and the second opto-electronic module mounted on the second circuit board over the second opening, the method comprising:
the first opto-electronic module emitting a first optical signal into the first opening; and
the second opto-electronic module receiving the first optical signal through the second opening.
